(19) United States
(12) Patent Application Publication
(10) Pub. No.: US 2026/0154795 A1
(43) Pub. Date: Jun. 4, 2026

(54) CORRECTING OVEREXPOSED IMAGES USING A DIFFUSION MODEL

(71) Applicant: Google LLC, Mountain View, CA (US)

(72) Inventors: Noa GLASER, Mountain View, CA (US); David JACOBS, Mountain View, CA (US); Dani LISCHINSKI, Mountain View, CA (US)

(73) Assignee: Google LLC, Mountain View, CA (US)

(21) Appl. No.: 19/405,122

(22) Filed: Dec. 1, 2025

Related U.S. Application Data
(60) Provisional application No. 63/727,150, filed on Dec. 2, 2024.

(51) Int. Cl. G06T 5/77; G06T 5/50; G06T 5/60; G06T 7/00; G06T 7/90

(52) U.S. Cl. CPC G06T 5/77; G06T 5/50; G06T 5/60; G06T 7/0002; G06T 7/90; G06T 2207/10024; G06T 2207/20081; G06T 2207/20084; G06T 2207/20221; G06T 2207/30168; G06T 2207/30201

(57) ABSTRACT

A method includes providing an input image to a diffusion model that is trained with image pairs that each include an overexposed image paired with a corresponding ground truth image, wherein one or more portions of the input image include overexposed pixels. The method further includes outputting, with the diffusion model, an intermediate image that includes corrected pixels that correspond to the one or more portions of the input image that include the overexposed pixels. The method further includes determining merge weights based on a brightness of pixels in the input image. The method further includes merging the intermediate image with the input image to generate an output image based on the merge weights. The method further includes performing tone mapping of the merged image.

### CROSS-REFERENCE TO RELATED APPLICATIONS

This application is a non-provisional application that claims priority under 35 U.S.C. § 119(e) to U.S. Provisional Patent Application No. 63/727,150, filed on Dec. 2, 2024 and entitled “Correcting Overexposed Images Using a Diffusion Model,” which is incorporated by reference herein by its entirety.

### BACKGROUND

When a camera (e.g., a camera on a mobile device) captures an image and too much light is detected by a camera sensor associated with the camera (e.g., when the scene is bright and/or the camera settings are inappropriate for the light conditions), the image is overexposed and lacks details, resulting in a washed-out looking image with details in the bright regions of the scene being lost. This may occur more frequently with older cameras or may be the result of capturing images in areas where the light cannot be avoided, such as at the top of a mountain during a bright day, or with inappropriate camera settings (e.g., long exposure time, large aperture, etc.).

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

A method includes providing an input image to a diffusion model that is trained with image pairs that each include an overexposed image paired with a corresponding ground truth image, wherein one or more portions of the input image include overexposed pixels. The method further includes outputting, with the diffusion model, an intermediate image that includes corrected pixels that correspond to the one or more portions of the input image that include the overexposed pixels. The method further includes determining merge weights based on a brightness of pixels in the input image. The method further includes merging the intermediate image with the input image to generate an output image based on the merge weights. The method further includes performing tone mapping of the merged image.

In some embodiments, determining the merge weights includes generating a weight mask that includes the merge weights by: determining, for each of the pixels in the input image, whether the brightness of the pixel meets a threshold brightness; for pixels that meet the threshold brightness, assigning a corresponding weight based on a first equation; and for pixels that do not meet the threshold brightness, assigning the corresponding weight based on a second equation. In some embodiments, the method further includes identifying coordinates of the overexposed pixels in the input image, identifying a subset of connected components of each of the overexposed pixels in the input image based on corresponding coordinates, and removing corresponding merge weights for the subset of connected components from the weight mask, where removing corresponding merge weights for the subset of connected components from the weight mask results in a speckled appearance of light in the merged image. In some embodiments, the weight mask is provided as input to the diffusion model.

In some embodiments, merging the intermediate image with the input image includes warping a color space of the intermediate image to match a color space of the input image using convolutional pyramids and performing the tone mapping includes conforming the warped image to an S-curve. In some embodiments, prior to providing the input image to the diffusion model, the method further comprises: generating an image color palette of the input image by clustering input image pixels based on colors in the input image; and determining to provide the input image to the diffusion model based on identifying, based on the image color palette, that one or more clusters of pixels in the input image meet a threshold Red Green Blue (RGB) pixel value. In some embodiments, prior to providing the input image to the diffusion model, the method further includes generating a weight map that quantifies a respective brightness of each input pixel associated with the input image and determining to provide the input image to the diffusion model based on the weight map.

In some embodiments, the method further includes detecting one or more people in the input image and generating one or more preserving masks that correspond to the one or more people, wherein the one or more preserving masks prevent the diffusion model from generating the corrected pixels that correspond to the one or more people in the input image. In some embodiments, prior to providing the input image to the diffusion model, the method further includes responsive to determining that the overexposed pixels in the input image do not include person pixels that correspond to one or more faces of one or more people, providing a suggestion to a user to correct overexposure in the input image.

A computing device comprises one or more processors and a memory coupled to the one or more processors, with instructions stored thereon that, when executed by the processor, cause the processor to perform operations. The operations include providing an input image to a diffusion model that is trained with image pairs that each include an overexposed image paired with a corresponding ground truth image, wherein one or more portions of the input image include overexposed pixels; outputting, with the diffusion model, an intermediate image that includes corrected pixels that correspond to the one or more portions of the input image that include the overexposed pixels; determining merge weights based on a brightness of pixels in the input image; merging the intermediate image with the input image to generate an output image based on the merge weights; and performing tone mapping of the merged image.

In some embodiments, determining the merge weights includes generating a weight mask that includes the merge weights by determining, for each pixel in the input image, whether the brightness of the pixel meets a threshold brightness, for pixels that meet the threshold brightness, assigning a corresponding weight based on a first equation, and for pixels that do not meet the threshold brightness, assigning the corresponding weight based on a second equation. In some embodiments, the operations further include identifying coordinates of the overexposed pixels in the input image, identifying a subset of connected components of each of the overexposed pixels in the input image based on corresponding coordinates, and removing corresponding merge weights for the subset of connected components from the weight mask, where removing corresponding merge weights for the subset of connected components from the weight mask results in a speckled appearance of light in the merged image. In some embodiments, the weight mask is provided as input to the diffusion model.

In some embodiments, merging the intermediate image with the input image includes warping a color space of the intermediate image to match a color space of the input image using convolutional pyramids and performing the tone mapping includes conforming the warped image to an S-curve. In some embodiments, wherein prior to providing the input image to the diffusion model, the operations further include generating an image color palette of the input image by clustering input image pixels based on colors in the input image and determining to provide the input image to the diffusion model based on identifying, based on the image color palette, that one or more clusters of pixels in the input image meet a threshold RGB pixel value.

A non-transitory computer-readable medium, with instructions stored thereon that, when executed by a processor, cause the processor to perform the operations. The operations include providing an input image to a diffusion model that is trained with image pairs that each include an overexposed image paired with a corresponding ground truth image, wherein one or more portions of the input image include overexposed pixels; outputting, with the diffusion model, an intermediate image that includes corrected pixels that correspond to the one or more portions of the input image that include the overexposed pixels; determining merge weights based on a brightness of pixels in the input image; merging the intermediate image with the input image to generate an output image based on the merge weights; and performing tone mapping of the merged image.

In some embodiments, determining the merge weights includes generating a weight mask that includes the merge weights by determining, for each pixel in the input image, whether the brightness of the pixel meets a threshold brightness, for pixels that meet the threshold brightness, assigning a corresponding weight based on a first equation, and for pixels that do not meet the threshold brightness, assigning the corresponding weight based on a second equation. In some embodiments, the operations further include identifying coordinates of the overexposed pixels in the input image, identifying a subset of connected components of each of the overexposed pixels in the input image based on corresponding coordinates, and removing corresponding merge weights for the subset of connected components from the weight mask, where removing corresponding merge weights for the subset of connected components from the weight mask results in a speckled appearance of light in the merged image. In some embodiments, the weight mask is provided as input to the diffusion model. In some embodiments, merging the intermediate image with the input image includes warping a color space of the intermediate image to match a color space of the input image using convolutional pyramids and performing the tone mapping includes conforming the warped image to an S-curve.

### BRIEF DESCRIPTION OF THE DRAWINGS

FIG. 1 is a block diagram of an example network environment, according to some embodiments described herein.

FIG. 2 is a block diagram of an example computing device, according to some embodiments described herein.

FIG. 3 is an example graph of weights determined for pixels in an input image as a function of pixel brightness, according to some embodiments described herein.

FIG. 4A illustrates an example input image that is overexposed, according to some embodiments described herein.

FIG. 4B illustrates an intermediate image that includes corrected pixels that are superimposed on the example input image of FIG. 3A, according to some embodiments described herein.

FIG. 4C illustrates an intermediate image that includes corrected pixels that are superimposed on the example input image of FIG. 3B where the overexposed pixels are located, according to some embodiments described herein.

FIG. 4D illustrates an example merged image that merges an intermediate image with the input image, according to some embodiments described herein.

FIG. 5 illustrates an example process of using a diffusion model to output an intermediate image, according to some embodiments described herein.

FIG. 6 illustrates an example method to generate a merged image that corrects overexposure in an input image, according to some embodiments described herein.

### DETAILED DESCRIPTION

### Overview

When a portion of an image exceeds a minimum or maximum intensity that can be represented with detail in an image, the result is called clipping. Overexposure is one example of clipping where bright areas in the image result in loss of details.

An overexposed image may be modified by changing levels of brightness/contrast, exposure, and highlights/shadows in the image. However, changing the pixel values for the entire image may result in loss of information in areas that were not affected by overexposure, resulting in an image that appears washed out.

The technology described herein is advantageously used to recover images that were captured with one or more overexposed portions. A user may capture an image on vacation, during a wedding, etc. in situations that are difficult or impossible to replicate. Instead of deleting the overexposed images, a media application generates a merged image that corrects for overexposure.

The media application provides an input image as input to a diffusion model that is trained with image pairs that each include an overexposed image paired with a corresponding ground truth image, where one or more portions of the input image include overexposed pixels. The ground truth images are reference images that do not include overexposed pixels. By pairing overexposed images with ground truth images, the diffusion model is trained to generate images with corrected pixels that are not overexposed. The diffusion model outputs an intermediate image that includes corrected pixels that correspond to the one or more portions of the input image that include the overexposed pixels.

The media application determines merge weights of the input image based on a brightness of pixels in the input image and merges the intermediate image with the input image to generate an output image based on the merge weights. If an input pixel is not overexposed, the merge weight may be low (e.g., 0.1, zero, etc.) for the input pixel. If an input pixel is overexposed, the merge weight may be high (e.g., 0.9, 1.0, etc.) for the input pixel. As a result, the merge weight is used to determine whether each initial pixel from the input image or each corrected pixel from the intermediate image is more dominant in a corresponding merged pixel in a merged image.

The process of generating brighter pixels may result in pixels with intensity values greater than the 255 maximum. The media application performs tone mapping on the merged image to adjust the intensity so that the intensity of each pixel in the merged image falls between 0 and 255.

In some embodiments, the media application preserves small highlights and creates a speckled appearance of light in the merged image. For example, the media application may identify the coordinates of the overexposed pixels in the input image, identify connected components (e.g., pixels that are next to an overexposed pixel on the x-axis and/or the y-axis), and prevent the connected components from being merged with corresponding pixels in the output image.

In some embodiments, the diffusion model may be applied to a downsampled, lower resolution version of the input image (e.g., an image of 1024×1024 pixels) and may output an intermediate image of the same size. In these embodiments, prior to the merging, the intermediate image is upsampled to be of a same size as the input image.

The media application may perform additional operations, such as determining that the overexposed pixels are not associated with a face of a person prior to providing the input image to the diffusion model. As a result, the output image does not include unrealistic versions of a person's face. In some embodiments, faces and bodies of a person may also be included in the intermediate image. For example, thresholding on pixel brightness for face or body pixels may be applied to only include faces or bodies when the intermediate image obtained from the diffusion model is of sufficient accuracy and is realistic.

In addition, prior to providing the input image to the diffusion model, the media application may determine that the image includes overexposed pixels. For example, the media application may generate an image color palette of the input image by clustering input image pixels based on colors in the input image and determine to provide the input image to the diffusion model based on using the image color palette to identify that one or more clusters of pixels in the input image meet a threshold Red Green Blue (RGB) pixel value. In another example, the media application may generate a weight map that quantifies a brightness of each input pixel associated with the input image and determine to provide the input image to the diffusion model based on the weight map.

### Environment

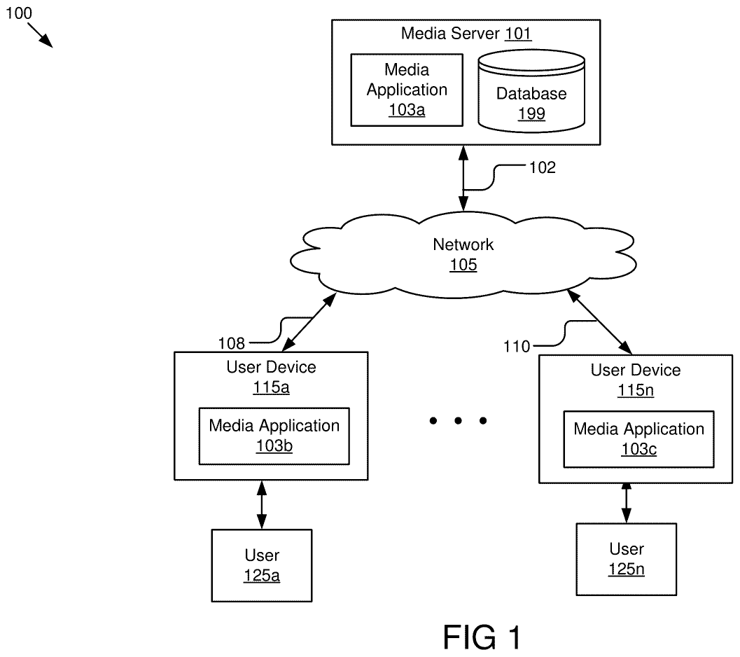

FIG. 1 illustrates a block diagram of an example environment 100. In some embodiments, the environment 100 includes a media server 101, a user device 115a, and a user device 115n coupled to a network 105. Users 125a, 125n may be associated with respective user devices 115a, 115n. In some embodiments, the environment 100 may include other servers or devices not shown in FIG. 1. In FIG. 1 and the remaining figures, a letter after a reference number, e.g., “115a,” represents a reference to the element having that particular reference number. A reference number in the text without a following letter, e.g., “115,” represents a general reference to embodiments of the element bearing that reference number.

The media server 101 may include a processor, a memory, and network communication hardware. In some embodiments, the media server 101 is a hardware server. The media server 101 is communicatively coupled to the network 105 via signal line 102. Signal line 102 may be a wired connection, such as Ethernet, coaxial cable, fiber-optic cable, etc., or a wireless connection, such as Wi-Fi®, Bluetooth®, or other wireless technology. In some embodiments, the media server 101 sends and receives data to and from one or more of the user devices 115a, 115n via the network 105. The media server 101 may include a media application 103a and a database 199.

The database 199 may store machine-learning models, training data sets, images, etc. The database 199 may also store social network data associated with users 125, user preferences for the users 125, etc.

The user device 115 may be a computing device that includes a memory coupled to a hardware processor. For example, the user device 115 may include a mobile device, a tablet computer, a mobile telephone, a wearable device, a head-mounted display, a mobile email device, a portable game player, a portable music player, a reader device, or another electronic device capable of accessing a network 105.

In the illustrated embodiment, user device 115a is coupled to the network 105 via signal line 108 and user device 115n is coupled to the network 105 via signal line 110. The media application 103 may be stored as media application 103b on the user device 115a and/or media application 103c on the user device 115n. Signal lines 108 and 110 may be wired connections, such as Ethernet, coaxial cable, fiber-optic cable, etc., or wireless connections, such as Wi-Fi®, Bluetooth®, or other wireless technology. User devices 115a, 115n are accessed by users 125a, 125n, respectively. The user devices 115a, 115n in FIG. 1 are used by way of example. While FIG. 1 illustrates two user devices, 115a and 115n, the disclosure applies to a system architecture having one or more user devices 115.

The media application 103 may be stored on the media server 101 or the user device 115. In some embodiments, the operations described herein are performed on the media server 101 or the user device 115. In some embodiments, some operations may be performed on the media server 101 and some may be performed on the user device 115. Performance of operations is in accordance with user settings. For example, the user 125a may specify settings that operations are to be performed on their respective device 115a and not on the media server 101. With such settings, operations described herein are performed entirely on user device 115a and no operations are performed on the media server 101. Further, a user 125a may specify that images and/or other data of the user is to be stored only locally on a user device 115a and not on the media server 101. With such settings, no user data is transmitted to or stored on the media server 101. Transmission of user data to the media server 101, any temporary or permanent storage of such data by the media server 101, and performance of operations on such data by the media server 101 are performed only if the user has agreed to transmission, storage, and performance of operations by the media server 101. Users are provided with options to change the settings at any time, e.g., such that they can enable or disable the use of the media server 101.

Machine learning models (e.g., neural networks or other types of models), if utilized for one or more operations, are stored and utilized locally on a user device 115, with specific user permission. Server-side models are used only if permitted by the user. Further, a trained model may be provided for use on a user device 115. During such use, if permitted by the user 125, on-device training of the model may be performed. Updated model parameters may be transmitted to the media server 101 if permitted by the user 125, e.g., to enable federated learning. Model parameters do not include any user data.

The media application 103 provides an input image as input to a diffusion model that is trained with image pairs that each include an overexposed image paired with a corresponding ground truth image. One or more portions of the input image include overexposed pixels. The diffusion model outputs an intermediate image that includes corrected pixels that correspond to the one or more portions of the input image that include the overexposed pixels. The media application 103 determines merge weights of the input image based on a brightness of pixels in the input image. The media application merges the intermediate image with the input image to generate an output image based on the merge weights.

In some embodiments, the media application 103 may be implemented using hardware including a central processing unit (CPU), a field-programmable gate array (FPGA), an application-specific integrated circuit (ASIC), machine learning processor/co-processor, any other type of processor, or a combination thereof. In some embodiments, the media application 103a may be implemented using a combination of hardware and software.

### Computing Device

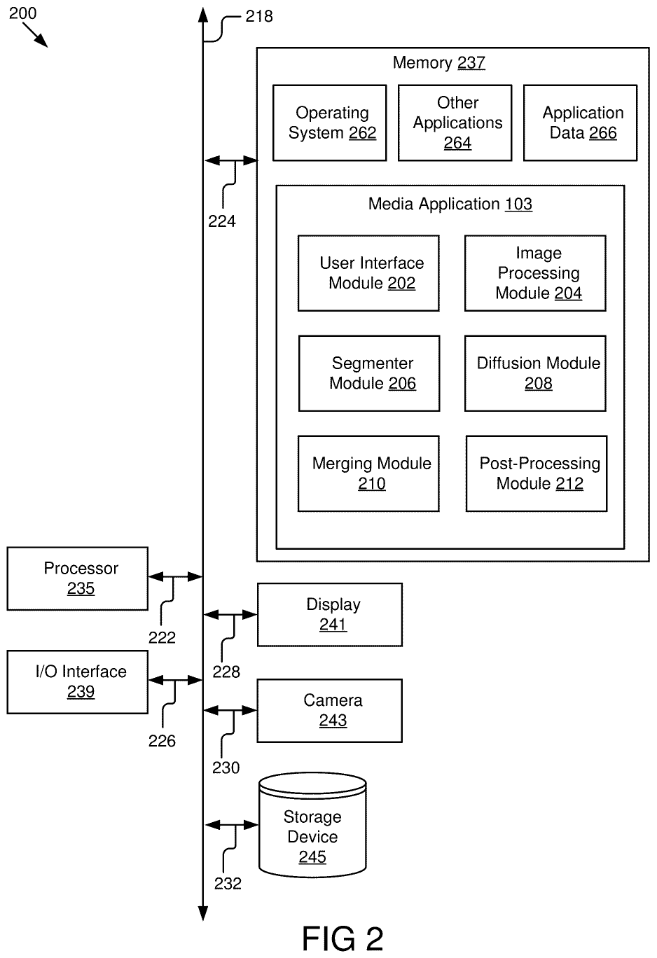

FIG. 2 is a block diagram of an example computing device 200 that may be used to implement one or more features described herein. Computing device 200 can be any suitable computer system, server, or other electronic or hardware device. In one example, computing device 200 is media server 101 used to implement the media application 103a. In another example, computing device 200 is a user device 115.

In some embodiments, computing device 200 includes a processor 235, a memory 237, an input/output (I/O) interface 239, a display 241, a camera 243, and a storage device 245 all coupled via a bus 218. The processor 235 may be coupled to the bus 218 via signal line 222, the memory 237 may be coupled to the bus 218 via signal line 224, the I/O interface 239 may be coupled to the bus 218 via signal line 226, the display 241 may be coupled to the bus 218 via signal line 228, the camera 243 may be coupled to the bus 218 via signal line 230, and the storage device 245 may be coupled to the bus 218 via signal line 232.

Processor 235 can be one or more processors and/or processing circuits to execute program code and control basic operations of the computing device 200. A “processor” includes any suitable hardware system, mechanism or component that processes data, signals or other information. A processor may include a system with a general-purpose central processing unit (CPU) with one or more cores (e.g., in a single-core, dual-core, or multi-core configuration), multiple processing units (e.g., in a multiprocessor configuration), a graphics processing unit (GPU), a field-programmable gate array (FPGA), an application-specific integrated circuit (ASIC), a complex programmable logic device (CPLD), dedicated circuitry for achieving functionality, a special-purpose processor to implement neural network model-based processing, neural circuits, processors optimized for matrix computations (e.g., matrix multiplication), or other systems. In some embodiments, processor 235 may include one or more co-processors that implement neural-network processing. In some embodiments, processor 235 may be a processor that processes data to produce probabilistic output, e.g., the output produced by processor 235 may be imprecise or may be accurate within a range from an expected output. Processing need not be limited to a particular geographic location or have temporal limitations. For example, a processor may perform its functions in real-time, offline, in a batch mode, etc. Portions of processing may be performed at different times and at different locations, by different (or the same) processing systems. A computer may be any processor in communication with a memory.

Memory 237 is typically provided in computing device 200 for access by the processor 235, and may be any suitable processor-readable storage medium, such as random access memory (RAM), read-only memory (ROM), Electrical Erasable Read-only Memory (EEPROM), Flash memory, etc., suitable for storing instructions for execution by the processor or sets of processors, and located separate from processor 235 and/or integrated therewith. Memory 237 can store software operating on the computing device 200 by the processor 235, including a media application 103.

The memory 237 may include an operating system 262, other applications 264, and application data 266. Other applications 264 can include, e.g., an image library application, an image management application, an image gallery application, communication applications, web hosting engines or applications, media sharing applications, etc. One or more methods disclosed herein can operate in several environments and platforms, e.g., as a stand-alone computer program that can run on any type of computing device, as a web application having web pages, as a mobile application (“app”) run on a mobile computing device, etc.

The application data 266 may be data generated by the other applications 264 or hardware of the computing device 200. For example, the application data 266 may include images used by the image library application and user actions identified by the other applications 264 (e.g., a social networking application), etc.

I/O interface 239 can provide functions to enable interfacing the computing device 200 with other systems and devices. Interfaced devices can be included as part of the computing device 200 or can be separate and communicate with the computing device 200. For example, network communication devices, storage devices (e.g., memory 237 and/or storage device 245), and input/output devices can communicate via I/O interface 239. In some embodiments, the I/O interface 239 can connect to interface devices such as input devices (keyboard, pointing device, touchscreen, microphone, scanner, sensors, etc.) and/or output devices (display devices, speaker devices, printers, monitors, etc.).

Some examples of interfaced devices that can connect to I/O interface 239 can include a display 241 that can be used to display content, e.g., images, video, and/or a user interface of an output application as described herein, and to receive touch (or gesture) input from a user. For example, display 241 may be utilized to display a user interface that includes a graphical guide on a viewfinder. Display 241 can include any suitable display device such as a liquid crystal display (LCD), light emitting diode (LED), or plasma display screen, cathode ray tube (CRT), television, monitor, touchscreen, three-dimensional display screen, or other visual display device. For example, display 241 can be a flat display screen provided on a mobile device, multiple display screens embedded in a glasses form factor or headset device, or a monitor screen for a computer device.

Camera 243 may be any type of image capture device that can capture images and/or video. In some embodiments, the camera 243 captures images or video that the I/O interface 239 transmits to the media application 103.

The storage device 245 stores data related to the media application 103. For example, the storage device 245 may store a training data set that includes labeled images, a machine-learning model, output from the machine-learning model, etc.

FIG. 2 illustrates an example media application 103, stored in memory 237, that includes a user interface module 202, an image processing module 204, a segmenter module 206, a diffusion module 208, a merging module 210, and a post-processing module 212.

The user interface module 202 generates graphical data for displaying a user interface that includes images. The user interface module 202 receives input images. The input image may be received from the camera 243 of the computing device 200 or from the media server 101 via the I/O interface 239.

The input image includes one or more portions of overexposed pixels. An overexposed pixel is defined as having a pixel value where one or more of the Red Green Blue (RGB) channels exceed a threshold RGB pixel value. For example, the threshold RGB value may be 235, the maximum value of 255, etc.

In some embodiments, the user interface module 202 generates a user interface that includes a suggestion to correct the input image. The user interface module 202 may receive an instruction to provide the suggestion based on a determination made by the image processing module 204 that the input image includes one or more portions of overexposed pixels, which is described in greater detail below with reference to the image processing module 204. In some embodiments, the user interface module 202 provides the suggestion responsive to the image processing module 204 determining that the overexposed pixels do not include pixels that correspond to one or more faces of one or more people. In some embodiments, the user interface module 202 provides the suggestion responsive to the image processing module 204 determining that the overexposed pixels include more than a threshold value of pixels that correspond to one or more faces of one or more people. For example, if some portion of a person's hair or forehead are overexposed, but most of the face is not overexposed, the user interface module 202 may provide the suggestion to correct the image.

In some embodiments, the diffusion module 208 automatically corrects an image that the image processing module 204 determines includes one or more portions of overexposed pixels. In some embodiments, the user interface module 202 generates a user interface where a user specifies user preferences that include options for automatic correction of images.

In some embodiments, the user interface includes an editing option to correct overexposed pixels. The user interface may include an option for a user to highlight different areas in an image that the user wants corrected for overexposure and/or an option to correct the image where the image processing module 204 identifies one or more portions of overexposed pixels.

The image processing module 204 processes input images. In some embodiments, and only upon user consent, the image processing module 204 performs person detection (e.g., face detection) to detect if one or more people (humans) are depicted in input images. If the overexposed pixels are associated with a face of a person, the image processing module 204 may not instruct the user interface module 202 to provide a suggestion to correct the input image.

In some embodiments, the suggestion to correct the input image is based on the image processing module 204 generating an image color palette by clustering input image pixels based on colors in the input image and identifying that one or more clusters of pixels in the input image meet a threshold RGB pixel value. The number of clusters of pixels may be based on a top number of most common colors (e.g., using k-means clustering), such as the top 10 colors in the input image. The threshold RGB value may be 235, 255, or other suitable value. In some embodiments, the image processing module 204 generates an exposure score based on the image color palette and the image processing module 204 instructs the user interface module 202 to provide a suggestion to correct the input image based on the exposure score meeting an exposure threshold value.

In some embodiments, the suggestion to correct the input image is based on generating a weight map from the input image. The image processing module 204 may generate a weight map that identifies, for each input pixel in the input image, a merge weight to apply while merging the input image with an upscaled intermediate image. If an input pixel is not overexposed, the weight map may include a merge weight that is low (e.g., 0.1, zero, etc.) for the input pixel. The image processing module 204 generates a weight mask from the weight map where the weight mask indicates a weight for each input pixel at a particular location in the input image.

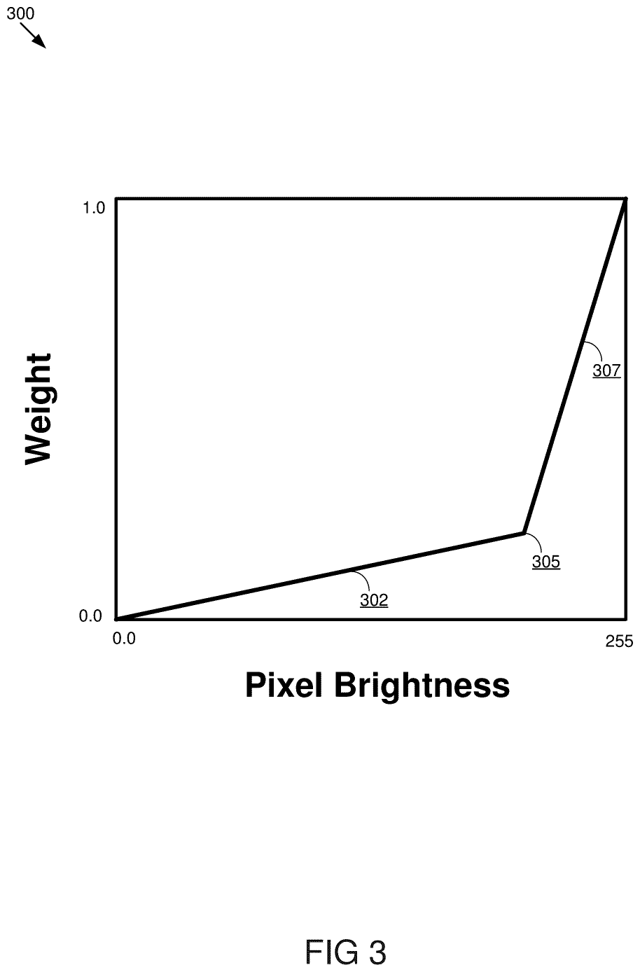

In some embodiments, the image processing module 204 determines the merge weights for the weight map based on applying a piece-wise linear function that assigns higher weights to the brightest regions of the input image. FIG. 3 is an example graph 300 of weights determined for pixels in an input image as a function of pixel brightness, according to some embodiments described herein. The image processing module 204 calculates a brightness for each pixel that is an average of the brightness of the RGB brightness values where the range is 0-255 because the input images are 8-bit images.

The piece-wise linear function includes a threshold brightness 305. If an input pixel meets or exceeds the threshold brightness, the image processing module 204 assigns a merge weight along a first line 302 to the pixel based on a first equation. In some embodiments, the first equation is:

$$merge weight = \sqrt{\frac{brightness - threshold}{saturation brightness - threshold}} \qquad Eq . 1$$

where, in some embodiments, the threshold is 180 and the saturation brightness is 240. If the input pixel fails to meet the threshold brightness 305, the image processing module 204 assigns a merge weight along a second line 307 based on a second equation. In some embodiments, the second equation is:

$$merge weight = \sqrt{1 - \frac{threshold - brightness}{threshold}} \qquad Eq . 2$$

where, in some embodiments, the threshold is 180. In some embodiments, if the brightness is 240 or over, the image processing module 204 assigns a merge weight of 1.

The image processing module 204 may determine whether to suggest a correction of the input image based on the weight mask by identifying a threshold percentage of merge weights that exceed a threshold weight value or a threshold percentage of merge weights within a particular region that exceed the threshold weight value. For example, if a predetermined number of pixels have a merge weight above zero, the image processing module 204 may instruct the user interface module 202 to provide a suggestion that a user select an option to correct the input image. In some embodiments, the image processing module 204 determines whether to suggestion a correction of the input image based on a threshold minimum number of merge weights that exceed the threshold weight value and a threshold maximum number of merge weights that exceed the threshold weight value. The threshold maximum number of merge weights may be used to avoid a situation where the diffusion model generates too much of an intermediate image, thereby increasing a likelihood that the intermediate image will include hallucinations.

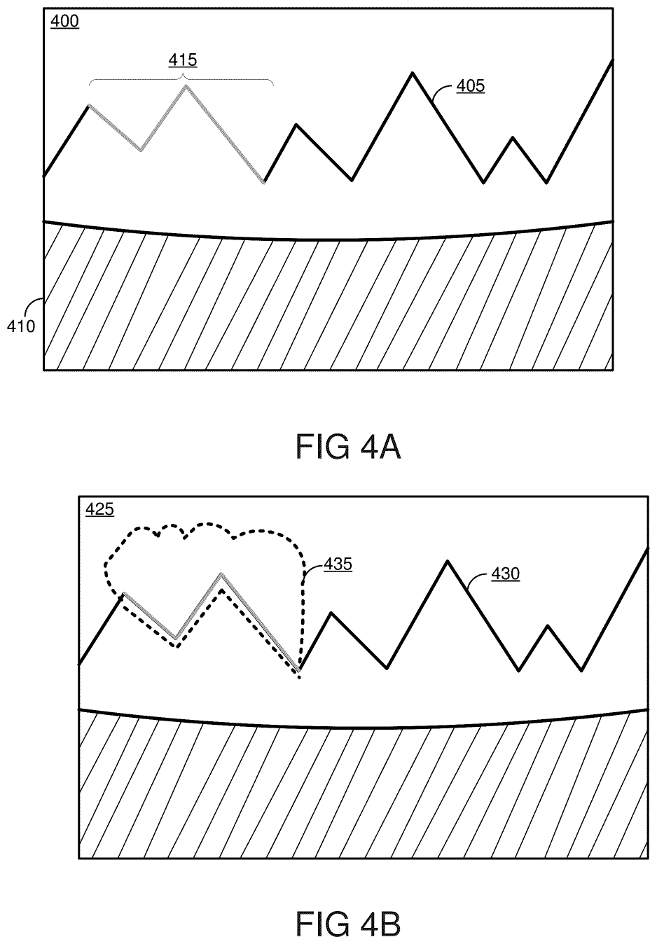

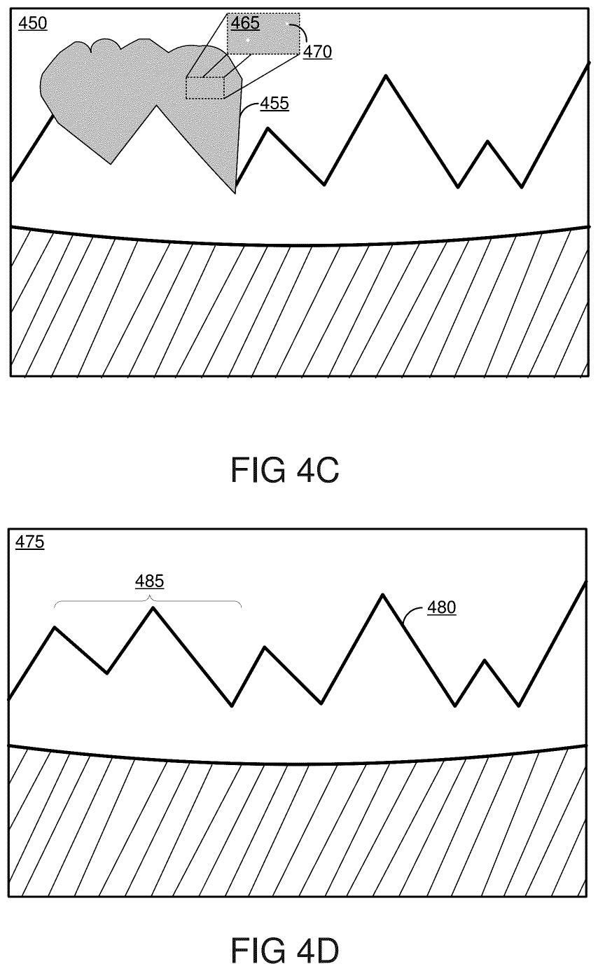

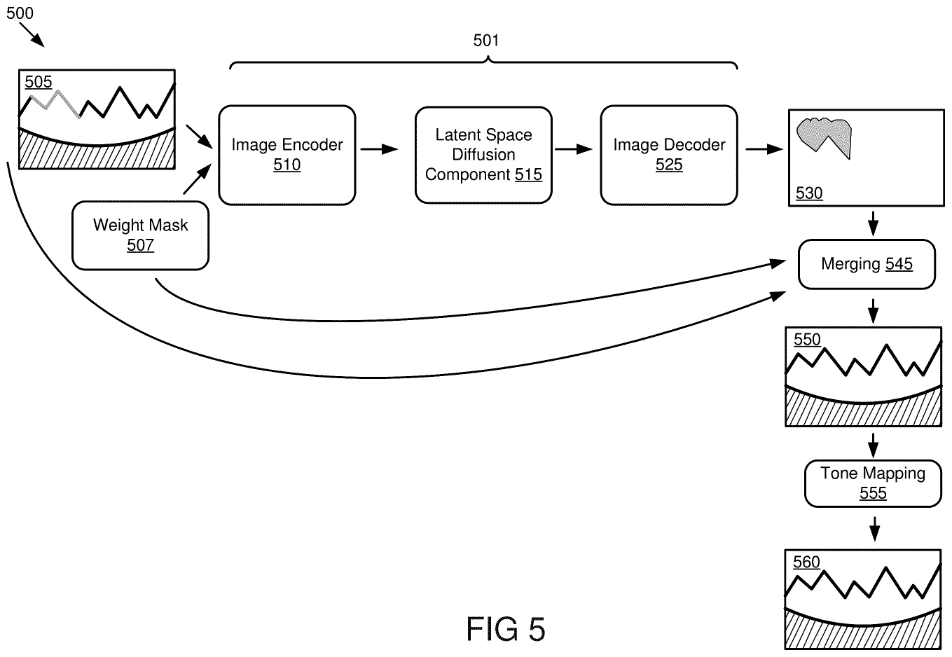

FIG. 4A illustrates an example input image 400 that is overexposed, according to some embodiments described herein. The input image 400 includes mountains 405 and a field 410. A portion 415 of the mountains 405 is overexposed. The portion 415 of the mountains may be identified based on generating an image color palette, a weight mask, user input that circles or otherwise selects the portion 415 of the mountain, etc.

FIG. 4B illustrates the example input image 425 of FIG. 4A with a border 435, according to some embodiments described herein. The mountains 430 include a border 435 that demarcates the portion of the input image 425 that has overexposed pixels. The area denoted by the border 435 is also referred to as a recovered area. The border 435 may be generated based on an image color palette, a weight mask, user input that circles or otherwise selects the portion 415 of the mountain, etc.

In some embodiments, the image processing module 204 preserves highlights and/or speckles in the input image by preventing a subset of the weights for pixels that are next to the overexposed pixels from being merged with the intermediate image. For example, the weight mask may be organized as a graph. The image processing module 204 identifies a first pixel in the graph, identifies connected components of the first pixel in the graph, and replaces corresponding merge weights (e.g., for instances where the merge weights are greater than 0) for the connected components from the weight mask (e.g., by setting the merge weight to zero). For example, the image processing module 204 may identify the connected components using a breadth-first search (or depth-first search, or other tree-traversal methods). In some embodiments, more than one input pixel may be selected for highlight preservation and multiple sets of connected components are identified.

In some embodiments, the image processing module 204 determines a subset of connected components and the merge weights are replaced if the size of the connected components are below a threshold value. For example, the merge weights are replaced if a number of pixels in a connected component is less than 0.04% of the pixels in the input image. If the number of connected components exceeds the threshold value, the image processing module 204 may reduce the number of connected components until the size is below the threshold value and then replace the merge weights.

In some embodiments, the image processing module 204 generates a gain map. A gain map identifies, for each pixel in the input image, a weight to apply to convert the initial image to an output image that compresses higher dynamic range luminance data to a lower range of Standard Dynamic Range (SDR) displays. The weight may be in the range of zero to one where zero represents no change and one represents a maximum allowable brightness difference. The gain map values indicate how much to multiply each pixel (in linear space). In some embodiments, the weight map is a scalar function that encodes pixel gain in a logarithmic space, relative to a maximum content boost and a minimum content boost.

In some embodiments, the media application 103 includes a segmenter module 206 that segments one or more objects including a face of a subject from an input image. The face segment includes pixels that correspond to a location of the face in the input image. In some embodiments, the segmenter module 206 segments the face of the subject in order to generate a preserving mask that the diffusion module 208 uses to prevent modification to the face during generation of an output image. In some embodiments, the segmenter module 206 segments the face of the subject in order to identify whether the overexposed pixels correspond to pixels associated with the face of the subject.

The segmenter module 206 may also segment more than the face, such as an entire body of a person in cases where the entire body is prevented from being modified. The body segment includes pixels that correspond to a location of the body in the input image. In some embodiments, the preserving mask includes all aspects of the input image except the part being modified.

In some embodiments, the segmenter module 206 uses an alpha map as part of a technique for distinguishing a foreground and a background of the input image during segmentation. The segmenter module 206 may also identify a texture of the selected object in the foreground of the input image.

The segmenter module 206 generates a preserving mask that encompasses at least a face of the subject. The preserving mask for the face may comprise pixels corresponding to the pixels of the face segment in the input image. In some embodiments, the preserving mask includes additional or different body parts, such as an entire head, hands, a body of the subject, etc. In some embodiments, the preserving mask is generated based on generating superpixels for the image and matching superpixel centroids to depth map values (e.g., obtained by the camera 243 using a depth sensor or by deriving depth from pixel values) to cluster detections based on depth. More specifically, depth values in a masked area may be used to determine a depth range and superpixels may be identified that fall within the depth range. Another technique for generating a mask includes weighing depth values based on a distance between the depth values and the mask, where weights were represented by a distance transform map.

In some embodiments, the segmenter module 206 may specify a circuit configuration (e.g., for a programmable processor, for a field programmable gate array (FPGA), etc.) enabling processor 235 to apply a machine-learning model. In some embodiments, the segmenter module 206 may include software instructions, hardware instructions, or a combination. In some embodiments, the segmenter module 206 may offer an application programming interface (API) that can be used by the operating system 262 and/or other applications 264 to invoke the segmenter module 206 e.g., to apply the machine-learning model to application data 266 to output the preserving mask.

The segmenter module 206 uses training data to generate a trained machine-learning model. For example, training data may include pairs of input images with one or more subjects and output images with one or more preserving masks.

Training data may be obtained from any source, e.g., a data repository specifically marked for training, data for which permission is provided for use as training data for machine learning, etc. In some embodiments, the training may be performed on the media server 101 that provides the training data directly to the user device 115, the training may be performed locally on the user device 115, or a combination of both.

In some embodiments, the segmenter module 206 uses weights that are taken from another application and are unedited/transferred. For example, in these embodiments, the trained model may be generated, e.g., on a different device, and be provided as part of the segmenter module 206. In various embodiments, the trained model may be provided as a data file that includes a model structure or form (e.g., that defines a number and type of neural network nodes, connectivity between nodes and organization of the nodes into a plurality of layers), and associated weights. The segmenter module 206 may read the data file for the trained model and implement neural networks with node connectivity, layers, and weights based on the model structure or form specified in the trained model.

The trained machine-learning model may include one or more model forms or structures. For example, model forms or structures can include any type of neural-network, such as a linear network, a deep-learning neural network that implements a plurality of layers (e.g., “hidden layers” between an input layer and an output layer, with each layer being a linear network), a convolutional neural network (e.g., a network that splits or partitions input data into multiple parts or tiles, processes each tile separately using one or more neural-network layers, and aggregates the results from the processing of each tile), a sequence-to-sequence neural network (e.g., a network that receives as input sequential data, such as words in a sentence, frames in a video, etc. and produces as output a result sequence), etc.

The model form or structure may specify connectivity between various nodes and organization of nodes into layers. For example, nodes of a first layer (e.g., an input layer) may receive data as input data or application data. Such data can include, for example, one or more pixels per node, e.g., when the trained model is used for analysis, e.g., of an input image. Subsequent intermediate layers may receive as input, output of nodes of a previous layer per the connectivity specified in the model form or structure. These layers may also be referred to as hidden layers. For example, a first layer may output a segmentation between a foreground and a background. A final layer (e.g., output layer) produces an output of the machine-learning model. For example, the output layer may receive the segmentation of the input image into a foreground and a background and output whether a pixel is part of a preserving mask or not. In some embodiments, model form or structure also specifies a number and/or type of nodes in each layer.

In different embodiments, the trained model can include one or more models. One or more of the models may include a plurality of nodes, arranged into layers per the model structure or form. In some embodiments, the nodes may be computational nodes with no memory, e.g., configured to process one unit of input to produce one unit of output. Computation performed by a node may include, for example, multiplying each of a plurality of node inputs by a weight, obtaining a weighted sum, and adjusting the weighted sum with a bias or intercept value to produce the node output. In some embodiments, the computation performed by a node may also include applying a step/activation function to the adjusted weighted sum. In some embodiments, the step/activation function may be a nonlinear function. In various embodiments, such computation may include operations such as matrix multiplication. In some embodiments, computations by the plurality of nodes may be performed in parallel, e.g., using multiple processors cores of a multicore processor, using individual processing units of a graphics processing unit (GPU), or special-purpose neural circuitry. In some embodiments, nodes may include memory, e.g., may be able to store and use one or more earlier inputs in processing a subsequent input. For example, nodes with memory may include long short-term memory (LSTM) nodes. LSTM nodes may use the memory to maintain “state” that permits the node to act like a finite state machine (FSM).

In some embodiments, the trained model may include embeddings or weights for individual nodes. For example, a model may be initiated as a plurality of nodes organized into layers as specified by the model form or structure. At initialization, a respective weight may be applied to a connection between each pair of nodes that are connected per the model form, e.g., nodes in successive layers of the neural network. For example, the respective weights may be randomly assigned, or initialized to default values. The model may then be trained, e.g., using training data, to produce a result.

Training may include applying supervised learning techniques. In supervised learning, the training data can include a plurality of inputs (e.g., images, preserving masks, etc.) and a corresponding groundtruth output for each input (e.g., a groundtruth mask that correctly identifies a portion of the subject, such as the subject's face, in each image). Based on a comparison of the output of the model with the groundtruth output, values of the weights are automatically adjusted, e.g., in a manner that increases a probability that the model produces the groundtruth output for the image.

In various embodiments, a trained model includes a set of weights, or embeddings, corresponding to the model structure. In some embodiments, the trained model may include a set of weights that are fixed, e.g., downloaded from a server that provides the weights. In various embodiments, a trained model includes a set of weights, or embeddings, corresponding to the model structure. In embodiments where data is omitted, the segmenter module 206 may generate a trained model that is based on prior training, e.g., by a developer of the segmenter module 206, by a third-party, etc. In some embodiments, the trained model may include a set of weights that are fixed, e.g., downloaded from a server that provides the weights.

In some embodiments, the trained machine-learning model receives an input image with one or more subjects. In some embodiments, the trained machine-learning model outputs one or more preserving masks that correspond to the one or more subjects. For example, the one or more preserving masks may be for one or more faces of the one or more subjects.

Conventional diffusion models are trained to generate images by progressively adding noise to input images (noising) and then training the diffusion model to perform a denoising process to recover the original image from the noise. The diffusion module 208 trains a diffusion model to receive an input image as input and output an intermediate image that includes corrected pixels that correspond to one or more portions of the input image that include overexposed pixels. In some embodiments, the input image is encoded in latent space and appended as extra channels to the noise being diffused. In some embodiments, the input image is provided to the diffusion model with conditioning inputs. Additional operations performed by the diffusion module 208 may include upscaling the intermediate image to match a resolution that corresponds to a resolution of the input image and merging the upscaled intermediate image with the input image based on the merge weights included in the weight mask. In some embodiments, these operations may be implemented in a separate module.

In some embodiments, the diffusion module 208 trains the diffusion model on an image inpainting task where the training data includes image pairs of a ground truth image and a corresponding image with random pixels or groups of pixels that are removed. As a result of training the diffusion model on inpainting tasks, the diffusion model is trained to receive an incomplete input image and output an image with generated pixels that replace (or fill in) any missing pixels. This is advantageously used during image generation for instances where, after corrected pixels are generated, some regions may have overexposed pixels that lack image details. The diffusion module 208 may perform inpainting of these regions.

In some embodiments, the diffusion module 208 performs fine-tuning of the trained diffusion model using image pairs that each include an overexposed image paired with a corresponding ground truth image. For training purposes, the diffusion module 208 may generate overexposed images from ground truth images by modifying a gain map of the ground truth images to expand a dynamic range of the ground truth images and then reduce the dynamic range of the overexposed images to 8-bits.

The gain map values are encoded in the data format as log 2 (gain multiple in linear space), where the upsampled linear gain applied in linear space is 2 (gain map value stored at each pixel). Before the gain multiple is applied, the gain map values have a minimum value of 1 to ensure that no region of the simulated overexposed image is darker than the original image. The diffusion module 208 creates several training pairs by creating different simulated overexposure renditions with accelerated overexposure (i.e., clipping) by multiplying the entire gain map by a value to create different variations of overexposed images.

In some embodiments, the ground truth images are selected by identifying images that were identified as being high-quality images. For example, the ground truth images may be selected from images with “good” or “gold” tags (where users curated the images by adding the tags, automatically generated using image ranking techniques, etc.), images that have a quality rating that meets 4/5, etc. In some embodiments, the diffusion module 208 excludes images from the ground truth images that include more than a predetermined threshold value of overexposed pixels (e.g., 10%).

The diffusion module 208 may train the diffusion model using the image pairs with the synthetic overexposed image pairs with the corresponding ground truth image such that the diffusion model parameters are adjusted to cause the diffusion model to preserve low and midtones and modify overexposed pixels when generating output images (by training the model to generate output images that are similar to corresponding ground truth images). In some embodiments, a pre-existing diffusion model may be adapted or fine-tuned by the training process to save the computational cost of training a brand-new diffusion model.

Once a diffusion model is trained using the pairs of overexposed and ground truth images, the diffusion model receives an input image and encodes the input image for latent space. For example, the diffusion model may include an encoder that compresses the input image to a lower resolution. In some embodiments, the diffusion component also receives a weight mask that is used to identify one or more region in the input image where the diffusion model generates output pixels. The compressed image is provided as input to a diffusion component that generates an intermediate image that includes corrected pixels that correspond to the one or more portions of the compressed input image that include the overexposed pixels. The diffusion model upscales the intermediate image. For example, the diffusion model includes a decoder that upscales the intermediate image to match a resolution of the input image before it was compressed. In some embodiments, the diffusion model includes a component (e.g., an autoencoder) that performs both encoding and decoding.

FIG. 4C illustrates an intermediate image 455 that includes corrected pixels that are superimposed on the example input image 450 of FIG. 4B where the overexposed pixels are located, according to some embodiments described herein. The intermediate image 455 corresponds to a recovered area where the overexposed pixels are replaced with corrected pixels. The corrected pixels in the intermediate image 455 may be darker than the input image 450.

Block 465 represents an enlarged version of the intermediate image 455 to highlight how the intermediate image 455 includes locations (e.g., location 470) where the corrected pixel is not merged with the overexposed pixel in the input image 450 (e.g., because 100% of the overexposed pixel is used and 0% of the corrected pixel is used). As a result of not merging the corrected pixel, the output image retains a speckled appearance.

FIG. 5 illustrates an example process 500 of using a diffusion model 501 to generate an intermediate image 530 from an input image 505 and a weight mask 507, according to some embodiments described herein. The diffusion model 501 includes an image encoder 510, a latent space diffusion component 515, and an image decoder 525.

The input image 505 and weight mask 507 are provided as input to the image encoder 510 that generates a compressed version of the input image 505. In this example, the input image 505 is the input image 400 of FIG. 4A and includes a portion of overexposed pixels. In some embodiments, the weight mask 507 is metadata that is stored as part of the input image 505.

The compressed image is provided as input to the latent space diffusion component 515, which generates an intermediate image. The intermediate image has the same low resolution as the compressed image output by the image encoder 510. The image decoder 525 upscales the intermediate image to result in an upscaled intermediate image 530 that matches a resolution that corresponds to the resolution of the input image 505. For example, the intermediate image output by the latent space diffusion component 515 may have a resolution of 1024×1024 pixels and the input image 505 may have a resolution of 3000×3000 pixels. The upscaling 535 may be performed using Lánczos interpolation. The upscaled intermediate image 530 includes corrected pixels that correspond to the overexposed pixels in the input image 505. Pixels of the upscaled intermediate image 530 are multiplied by smoothly interpolated multiples such that they match the values of the input image 505 along mask boundaries.

The upscaled intermediate image 530 is merged 545 with the input image 505 based on the weight mask 507. As a result of the merging 545, a merged image 550 is generated where the overexposed pixels are replaced with corrected pixels. Tone mapping 555 is performed on the merged image 550 and an output image 560 is generated.

In some embodiments, the diffusion model may output an intermediate image that does not perfectly align with the portion of the input image that includes overexposed pixels. The diffusion model may include an inpainting feature that replaces remaining pixels with inpainted pixels. The diffusion model may use a gradient of neighborhood pixels to determine properties of the corrected pixels and well-lit input pixels (i.e., pixels that are not overexposed).

The merging module 210 merges the upscaled intermediate image with the input image to generate an output image based on merge weights in the weight mask. For example, if one of the merge weights in the merge mask is 0.1, 10% of the intermediate image is merged with 90% of the input image. In another example, if one of the merge weights in the merge mask is 0.95, 95% of the intermediate image is merged with 5% of the input image. As a result of merging the two images, the colors and full-resolution details of the portions of the input image that do not include overexposed pixels are retained while the overexposed pixels in the input image are replaced with corrected pixels from the intermediate image that include additional details and textures.

In some embodiments, the merging module 210 merges the upscaled intermediate image with the input image includes warping a color space of the intermediate image using convolutional pyramids. In some embodiments the merging module 210 samples the corrected pixels along a border of the intermediate image are sampled. For example, in FIG. 4C, the corrected pixels are sampled from a border of the intermediate image 455. The merging module 210 determines a ratio on each location along the border of the intermediate image where the ratio represents a ratio between a brightness of the input image as compared to a brightness of the intermediate image. For example, the input image may be three times as bright as the intermediate image.

The merging module 210 uses the ratios to obtain a convolutional pyramid of resolutions. In some embodiments, the diffusion model performs convolutions with a predetermined number of fixed-width kernels (e.g., three, four, etc.) while downsampling and upsampling the merged input image and intermediate image to operate on the different levels of the convolutional pyramid where the number of levels corresponds to the number of layers in the CNN.

In some embodiments, the diffusion module 208 excludes ratios that are determined to be outliers, for example, ratios that are within a predetermined value of the other ratios (e.g., if one ratio is 10 and the other ratios are between 3-5, the ratio of 10 is excluded). The diffusion module 208 multiplies the corrected pixels by a smooth manifold of multiples.

Once the convolutional pyramid is applied, the diffusion module 208 performs tone mapping of the warped image to conform to an S-curve. Tone mapping is a technique for mapping one set of colors, for example, to another set of colors to approximate the appearance of HDR images in a medium that has a more limited range. The tone mapping is performed because one or more pixels of the warped image may exceed the 0-255 range of an 8-bit image. The tone mapping outputs a tonemapped image is an 8-bit image.

FIG. 4D illustrates an example output image 475 that merges an intermediate image with the input image, according to some embodiments described herein. The output image 475 includes mountains 480 where the section 485 that previously included overexposed pixels now includes recovered details and textures.

### Method

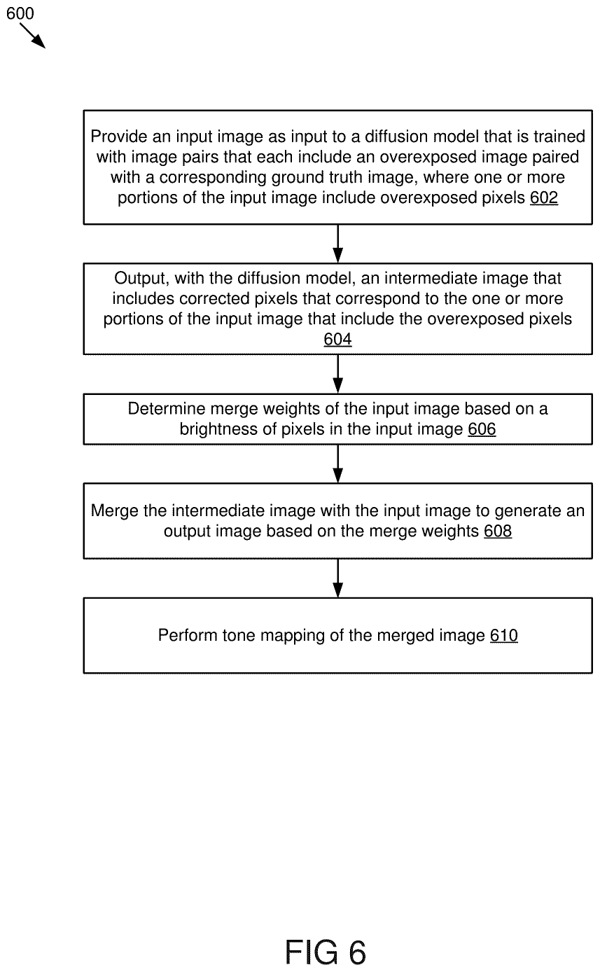

FIG. 6 illustrates an example method 600 to generate a merged image that corrects overexposure in an input image, according to some embodiments described herein. The method 600 may be performed by the computing device 200 in FIG. 2. In some embodiments, the method 600 is performed by the user device 115, the media server 101, or in part on the user device 115 and in part on the media server 101 in FIG. 1.

The method 600 of FIG. 6 may begin at block 602. At block 602, an input image is provided as input to a diffusion model that is trained with image pairs that each include an overexposed image paired with a corresponding ground truth image, where one or more portions of the input image include overexposed pixels. In some embodiments, the input image is provided responsive to determining that the overexposed pixels in the input image are not associated with a face of a person.

In some embodiments, prior to providing the input image to the diffusion model, the method 600 further includes responsive to determining that the overexposed pixels in the input image do not include person pixels that correspond to one or more faces of one or more people, providing a suggestion to a user to correct overexposure in the input image. In some embodiments, prior to providing the input image to the diffusion model, the method 600 further includes generating an image color palette of the input image by clustering input image pixels based on colors in the input image; and determining to provide the input image to the diffusion model based on identifying, based on the image color palette, that one or more clusters of pixels in the input image meet a threshold Red Green Blue (RGB) pixel value. In some embodiments, prior to providing the input image to the diffusion model, the method 600 further includes generating a weight map that quantifies a respective brightness of each input pixel associated with the input image; and determining to provide the input image to the diffusion model based on the weight map. Block 602 may be followed by block 604.

At block 604, the diffusion model outputs an intermediate image that includes corrected pixels that correspond to the one or more portions of the input image that include the overexposed pixels. Block 604 may be followed by block 606.

At block 606, merge weights of the input image are determined based on a brightness of pixels in the input image. In some embodiments, the merge weights are determined by generating a weight mask that includes the merge weights by: determining, for each of the pixels in the input image, whether the brightness of the pixel meets a threshold brightness; for pixels that meet the threshold brightness, assigning a corresponding weight based on a first equation; and for pixels that do not meet the threshold brightness, assigning the corresponding weight based on a second equation, where the merge weights used to merge the intermediate image with the input image are derived from the weight mask. In some embodiments, the overexposed pixels are organized in a graph and the method 600 further includes preserving a subset of the overexposed pixels in the input image by identifying a first pixel in the input image, identifying connected components of the first pixel in the graph, and removing the merge weights for the connected components from the weight mask. Block 606 may be followed by block 608.

At block 608, the intermediate image is merged with the input image to generate an output image based on the merge weights. In some embodiments, merging the intermediate image with the input image includes warping a color space of the intermediate image to match a color space of the input image using convolutional pyramids and performing the tone mapping includes conforming the warped image to an S-curve. Block 608 may be followed by block 610.

At block 610, tone mapping of the merged image is performed.

In some embodiments, the method 600 further includes detecting one or more people in the input image; and generating one or more preserving masks that correspond to the one or more people, where the one or more preserving masks prevent the diffusion model from generating the corrected pixels that correspond to the one or more people in the input image.

Further to the descriptions above, a user may be provided with controls allowing the user to make an election as to both if and when systems, programs, or features described herein may enable collection of user information (e.g., information about a user's social network, social actions, or activities, profession, a user's preferences, or a user's current location), and if the user is sent content or communications from a server. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over what information is collected about the user, how that information is used, and what information is provided to the user.

In the above description, for purposes of explanation, numerous specific details are set forth in order to provide a thorough understanding of the specification. It will be apparent, however, to one skilled in the art that the disclosure can be practiced without these specific details. In some instances, structures and devices are shown in block diagram form in order to avoid obscuring the description. For example, the embodiments can be described above primarily with reference to user interfaces and particular hardware. However, the embodiments can apply to any type of computing device that can receive data and commands, and any peripheral devices providing services.

Reference in the specification to “some embodiments” or “some instances” means that a particular feature, structure, or characteristic described in connection with the embodiments or instances can be included in at least one embodiment of the description. The appearances of the phrase “in some embodiments” in various places in the specification are not necessarily all referring to the same embodiments.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms including “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission, or display devices.

The embodiments of the specification can also relate to a processor for performing one or more steps of the methods described above. The processor may be a special-purpose processor selectively activated or reconfigured by a computer program stored in the computer. Such a computer program may be stored in a non-transitory computer-readable storage medium, including, but not limited to, any type of disk including optical disks, ROMs, CD-ROMs, magnetic disks, RAMS, EPROMs, EEPROMs, magnetic or optical cards, flash memories including USB keys with non-volatile memory, or any type of media suitable for storing electronic instructions, each coupled to a computer system bus.

The specification can take the form of some entirely hardware embodiments, some entirely software embodiments or some embodiments containing both hardware and software elements. In some embodiments, the specification is implemented in software, which includes, but is not limited to, firmware, resident software, microcode, etc.

Furthermore, the description can take the form of a computer program product accessible from a computer-usable or computer-readable medium providing program code for use by or in connection with a computer or any instruction execution system. For the purposes of this description, a computer-usable or computer-readable medium can be any apparatus that can contain, store, communicate, propagate, or transport the program for use by or in connection with the instruction execution system, apparatus, or device.

A data processing system suitable for storing or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

What is claimed is:

1. A computer-implemented method comprising:
providing an input image to a diffusion model that is trained with image pairs that each include an overexposed image paired with a corresponding ground truth image, wherein one or more portions of the input image include overexposed pixels;
outputting, with the diffusion model, an intermediate image that includes corrected pixels that correspond to the one or more portions of the input image that include the overexposed pixels;
determining merge weights based on a brightness of pixels in the input image;
merging the intermediate image with the input image to generate an output image based on the merge weights; and
performing tone mapping of the merged image.

2. The method of claim 1, wherein determining the merge weights includes generating a weight mask that includes the merge weights by:
determining, for each pixel in the input image, whether the brightness of the pixel meets a threshold brightness;
for pixels that meet the threshold brightness, assigning a corresponding weight based on a first equation; and
for pixels that do not meet the threshold brightness, assigning the corresponding weight based on a second equation.

3. The method of claim 2, further comprising:
identifying coordinates of the overexposed pixels in the input image;
identifying a subset of connected components of each of the overexposed pixels in the input image based on corresponding coordinates; and
removing corresponding merge weights for the subset of connected components from the weight mask;
wherein removing corresponding merge weights for the subset of connected components from the weight mask results in a speckled appearance of light in the merged image.

4. The method of claim 2, wherein the weight mask is provided as input to the diffusion model.

5. The method of claim 1, wherein:
merging the intermediate image with the input image includes warping a color space of the intermediate image to match a color space of the input image using convolutional pyramids; and
performing the tone mapping includes conforming the warped image to an S-curve.

6. The method of claim 1, wherein prior to providing the input image to the diffusion model, the method further comprises:
generating an image color palette of the input image by clustering input image pixels based on colors in the input image; and
determining to provide the input image to the diffusion model based on identifying, based on the image color palette, that one or more clusters of pixels in the input image meet a threshold Red Green Blue (RGB) pixel value.

7. The method of claim 1, wherein prior to providing the input image to the diffusion model, the method further comprises:
generating a weight map that quantifies a respective brightness of each input pixel associated with the input image; and
determining to provide the input image to the diffusion model based on the weight map.

8. The method of claim 1, further comprising:
detecting one or more people in the input image; and
generating one or more preserving masks that correspond to the one or more people, wherein the one or more preserving masks prevent the diffusion model from generating the corrected pixels that correspond to the one or more people in the input image.

9. The method of claim 1, wherein prior to providing the input image to the diffusion model, the method further comprises:
responsive to determining that the overexposed pixels in the input image do not include person pixels that correspond to one or more faces of one or more people, providing a suggestion to a user to correct overexposure in the input image.

10. A system comprising:
one or more processors; and
a memory coupled to the one or more processors, with instructions stored thereon that, when executed by the processor, cause the processor to perform operations comprising:
providing an input image to a diffusion model that is trained with image pairs that each include an overexposed image paired with a corresponding ground truth image, wherein one or more portions of the input image include overexposed pixels;
outputting, with the diffusion model, an intermediate image that includes corrected pixels that correspond to the one or more portions of the input image that include the overexposed pixels;
determining merge weights based on a brightness of pixels in the input image;
merging the intermediate image with the input image to generate an output image based on the merge weights; and
performing tone mapping of the merged image.

11. The system of claim 10, wherein determining the merge weights includes generating a weight mask that includes the merge weights by:
determining, for each pixel in the input image, whether the brightness of the pixel meets a threshold brightness;
for pixels that meet the threshold brightness, assigning a corresponding weight based on a first equation; and
for pixels that do not meet the threshold brightness, assigning the corresponding weight based on a second equation.

12. The system of claim 11, wherein the operations further include:
identifying coordinates of the overexposed pixels in the input image;
identifying a subset of connected components of each of the overexposed pixels in the input image based on corresponding coordinates; and
removing corresponding merge weights for the subset of connected components from the weight mask;
wherein removing corresponding merge weights for the subset of connected components from the weight mask results in a speckled appearance of light in the merged image.

13. The system of claim 11, wherein the weight mask is provided as input to the diffusion model.

14. The system of claim 11, wherein:
merging the intermediate image with the input image includes warping a color space of the intermediate image to match a color space of the input image using convolutional pyramids; and
performing the tone mapping includes conforming the warped image to an S-curve.

15. The system of claim 11, wherein prior to providing the input image to the diffusion model, the operations further include:
generating an image color palette of the input image by clustering input image pixels based on colors in the input image; and
determining to provide the input image to the diffusion model based on identifying, based on the image color palette, that one or more clusters of pixels in the input image meet a threshold Red Green Blue (RGB) pixel value.

16. A non-transitory computer-readable medium with instructions that, when executed by one or more processors, cause the one or more processors to perform operations, the operations comprising:
providing an input image to a diffusion model that is trained with image pairs that each include an overexposed image paired with a corresponding ground truth image, wherein one or more portions of the input image include overexposed pixels;
outputting, with the diffusion model, an intermediate image that includes corrected pixels that correspond to the one or more portions of the input image that include the overexposed pixels;
determining merge weights based on a brightness of pixels in the input image;
merging the intermediate image with the input image to generate an output image based on the merge weights; and
performing tone mapping of the merged image.

17. The computer-readable medium of claim 16, wherein determining the merge weights includes generating a weight mask that includes the merge weights by:
determining, for each pixel in the input image, whether the brightness of the pixel meets a threshold brightness;
for pixels that meet the threshold brightness, assigning a corresponding weight based on a first equation; and
for pixels that do not meet the threshold brightness, assigning the corresponding weight based on a second equation.

18. The computer-readable medium of claim 17, wherein the operations further include:
identifying coordinates of the overexposed pixels in the input image;
identifying a subset of connected components of each of the overexposed pixels in the input image based on corresponding coordinates; and
removing corresponding merge weights for the subset of connected components from the weight mask;
wherein removing corresponding merge weights for the subset of connected components from the weight mask results in a speckled appearance of light in the merged image.

19. The computer-readable medium of claim 17, wherein the weight mask is provided as input to the diffusion model.

20. The computer-readable medium of claim 16, wherein:
merging the intermediate image with the input image includes warping a color space of the intermediate image to match a color space of the input image using convolutional pyramids; and
performing the tone mapping includes conforming the warped image to an S-curve.
